(19) United States
(12) Patent Application Publication
(10) Pub. No.: US 2011/0244263 A1
(43) Pub. Date: Oct. 6, 2011

(54) PATTERNING USING ELECTROLYSIS

(76) Inventors: Peicheng Ku, Ann Arbor, MI (US); Leung Kway Lee, Ann Arbor, MI (US)

(21) Appl. No.: 13/079,801

(22) Filed: Apr. 4, 2011

Related U.S. Application Data
(60) Provisional application No. 61/341,660, filed on Apr. 2, 2010.

(51) Int. Cl. B32B 3/30; C25D 5/02; C25F 3/14; B32B 3/10

(52) U.S. Cl. 428/601; 205/118; 205/640; 216/16; 428/172

(57) ABSTRACT

A method of patterning and an article having a patterned structure defined therein are provided. The method comprises the steps of providing a substrate having a patterned conductive metal film disposed thereon. The patterned conductive metal film has at least one raised feature. The patterned conductive metal film defines at least one recess therein that is adjacent to the at least one raised feature. A surface of the substrate is exposed in the at least one recess. The pattern is modified through electrolysis in an electrodeposition setup including an electrolyte and two electrodes. The patterned conductive metal film is one of the electrodes during electrolysis. The method is ideal for shrinking initial patterns having features that are on the magnitude of microscale dimensions to obtain a final pattern having features that are on the magnitude of nanoscale dimensions.

### CROSS-REFERENCE TO RELATED APPLICATIONS

The subject patent application claims priority to, and all the benefits of, U.S. Provisional Patent Application Ser. No. 61/341,660 filed on Apr. 2, 2010. The entirety of this provisional patent application is expressly incorporated herein by reference.

### BACKGROUND OF THE INVENTION

1. Field of the Invention

The present invention generally relates to a method of patterning and an article having a patterned structure defined therein. More specifically, the method involves patterning using electrolysis.

2. Description of the Related Art

Many patterning techniques, especially for patterning on the scale of nanometers (referred to as “nanolithography”), suffer from various shortcomings including low throughput due to time-consuming direct pattern-writing (e.g. electron beam lithography and focused ion beam milling) and high-maintenance cost. As such, they are inadequate for the mass production of devices in the field of nanotechnology. In many fields of nanotechnology, the capability of executing wafer-scale nanolithography, hence the mass production of nanoscale devices, has indeed become the bottleneck. This is especially true in the bio-related subjects, in which a large number of the nanoscale devices are required for a complete sampling. Examples of nanoscale devices that can benefit from mass production are found in nano-cantilever chemical sensor arrays and zeroth-mode waveguides for resolving single-molecular dynamics.

Conventional photolithography techniques are mature technologies that can provide high throughput for mass production of microscale devices (e.g. micro-electro-mechanical system, MEMS). Conventional photolithography techniques use tools such as contact aligners, steppers and interferometers (interference lithography). While the conventional photolithography techniques have played important roles in mass production of microscale devices, their major drawback is the resolution limit—the patterns are usually limited to features having dimensions of larger than 500 nm. The 500-nm scale limit can not fulfill many promising properties of nanoscale devices, which often require dimension of less than 200 nm.

Various pattern shrinkage techniques may be employed to achieve nanoscale patterns. The pattern shrinkage techniques start with larger, microscale patterns and then shrink the microscale patterns to the desired nanoscale dimensions. The pattern shrinkage techniques can be considered as convenient add-on techniques to readily established microscale photolithographic techniques. Recently, various pattern shrinkage techniques have been developed including the SAFIER™ (shrink assist film for enhanced resolution) process, the thermal reflow process, the RELAC (resolution enhancement lithography assisted by chemical shrink) process, the CASS (coating assisted shrinkage of space) process, and the ALD (atomic layer deposition) process. However, uniformity and control problems persist for the processes that involve shrinkage of a patterned polymeric resist layer such as the SAFIER™, thermal reflow, RELAC, and CASS processes. One reason for why uniformity and control problems may be associated with the above processes may be because in these processes, heat is used to induce chemical or thermal stress-related changes in the polymeric resist layer. The chemical or thermal stress-related changes may lead to pattern shrinkage in the resist layer. As heat distribution varies based upon substrate materials and pattern geometries, degree and quality of the pattern shrinkage may also vary, thereby resulting in poor control of shrinkage in these processes. While the ALD process provides precisely controlled pattern shrinkage down to Ångstrom (Å) length scale, the deposition mechanism of the ALD process is slow and may take an excessive amount of time under some circumstances. Moreover, the ALD process is carried out with very high conformity, so the bottom surface of any pattern openings that have been exposed by earlier processes will be uniformly masked. This may create difficulties for re-opening the patterns for subsequent pattern-transfer steps.

In view of the foregoing, there remains an opportunity to further refine nanopatterning techniques to avoid the aforementioned control and throughput issues associated with existing nanopatterning and pattern shrinkage techniques.

In the past, electrodeposition (or electroplating) techniques have been employed to modify dimensions of nanostructures in unique applications. For example, electrodeposition techniques have been utilized for reducing the gap between two electrodes down to nanometer-dimension. Electrodeposition techniques have also been used for to fabricate metallic nanowires from the undercut of a metal film. Electrodeposition techniques have also been used to perform super-filling of sub-100 nm contact holes. However, there has been no suggestion to date to utilize electrodeposition techniques for nanoscale patterning in wafer-scale.

### SUMMARY OF THE INVENTION AND ADVANTAGES

A method of patterning and an article having a patterned structure defined therein are provided. The method comprises the steps of providing a substrate having a patterned conductive metal film disposed thereon. The patterned conductive metal film has at least one raised feature. The patterned conductive metal film defines at least one recess therein that is adjacent to the at least one raised feature. A surface of the substrate is exposed in the at least one recess. The pattern is modified through electrolysis in an electrodeposition setup including an electrolyte and two electrodes. The patterned conductive metal film is one of the electrodes during electrolysis.

The method of the instant invention is ideal for shrinking initial patterns having features that are on the magnitude of microscale dimensions to obtain a final pattern having features that are on the magnitude of nanoscale dimensions. The instant method of patterning using electrolysis provides an alternative to existing pattern shrinkage techniques and demonstrates well-controlled and uniform shrinkage down to sub-200 nm, and even down to and below sub-100 nm, dimensions over a large sample area. Further, through the method of the instant invention, the advantages of conventional lithography techniques for expedient mass production of microscale patterns can be realized while producing nanoscale patterns.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic side view of a method of patterning utilizing electrodeposition in accordance with the method of the instant invention to produce an article having a patterned structure defined therein;

FIG. 2 is a schematic side view of a method of patterning utilizing electroetching in accordance with the method of the instant invention to produce an article having a patterned structure defined therein;

FIG. 3 is a schematic perspective view of a typical electrodeposition setup that may be used to perform the method in accordance with the instant invention;

FIG. 4 is an optical microscope image of an article including a patterned structure of lines and recesses formed through electrodeposition and insulating layer etching in accordance with the method of the instant invention;

FIG. 5 is a series of scanning electron micrographs (SEM) illustrating pattern shrinkage in an article having a nanopatterned structure defined therein after different durations of electrodeposition times. SEMs in the top row show the top-view of the article while the bottom row shows the cross-section of the article. The widths of recesses in the respective micrographs are 515 nm, 290 nm and 80 nm, corresponding to electrodeposition times of 8 minutes, 15 minutes, and 20 minutes, respectively. All scale-bars (white) shown in the figures represent actual length of 500 nm.

FIG. 6 is a graph illustrating the relationship between base widths of recesses between lines in a patterned conductive metal film and the thickness of electrodeposited metal films formed through electrodeposition as a function of electrodeposition time. The base width and deposition thickness are measured from the cross-sectional SEM images shown in FIG. 5.

FIG. 7(a) is a graph illustrating plots of deposition rates at different deposition times for electrodeposited metal films on sidewalls and on upper surfaces of patterned conductive metal films. The deposition rate is calculated from the cross-sectional SEM images shown in FIG. 5. The sidewall deposition rate shows an increasing trend.

FIG. 7(b) is a schematic top view illustrating a hypothetical dog-bone phenomenon that may occur in electrodeposited metal films formed through electrodeposition, although the thickness profile shown is not representative of actual results.

FIG. 7(c) is a schematic side view of the hypothetical dog-bone profile that may occur in electrodeposited metal films formed through electrodeposition given long enough electrodeposition times. As with FIG. 7(a, the thickness profile shown is not representative of actual results;

FIG. 8 is a scanning electron micrograph (SEM) of circular holes in an electrodeposited gold film produced in accordance with the method of the instant invention after electrodeposition for 13 minutes. The diameter of the circular holes is observed to be about 100 nm, as shown in the figure.

FIG. 9(a) is a scanning electron micrograph (SEM) top view of an electrodeposited metal film including lines with a recess defined therebetween, with an insulating layer disposed beneath the electrodeposited metal film; and

FIG. 9(b) is a scanning electron micrograph (SEM) top view showing pattern transfer into the insulating layer underlying the electrodeposited metal film as a result of using reactive ion etching (RIE) and after the removal of the electrodeposited metal film. The width of the recesses in the insulating layer is about 90 nm.

### DETAILED DESCRIPTION OF THE INVENTION

The instant invention provides a method of patterning using electrolysis as a novel pattern shrinkage technique to shrink patterns readily established by conventional patterning techniques down to smaller dimensions. The method is not necessarily limited to any particular scale of the initial pattern or the final pattern. However, the method of the instant invention is ideal for shrinking initial patterns having features that are on the magnitude of microscale dimensions to obtain a final pattern having features that are on the magnitude of nanoscale dimensions. The instant method of patterning using electrolysis provides an alternative to existing pattern shrinkage techniques and demonstrates well-controlled and uniform shrinkage down to sub-200 nm, and even down to and below sub-100 nm, dimensions over a large sample area. Further, through the method of the instant invention, the advantages of conventional lithography techniques for expedient mass production of microscale patterns can be realized while producing nanoscale patterns.

For the method, a substrate (indicated at numerals 14 and 16) is provided that has a patterned conductive metal film (indicated at elements 12 and 18) disposed thereon. Although not required, the method may include the step of forming the substrate 14, 16. The substrate may comprise a single layer (such as the layer indicated at 14) that may be formed from silicon or glass, or that may be formed from metals and plastics. When the substrate includes the single layer 14, the material of the substrate 14 is unimportant and any solid substrate material can be used for the substrate 14.

Alternatively, the substrate may include a sublayer 14 and an insulating layer 16 that is disposed on the sublayer 14. The insulating layer 16 may be deposited on the substrate 14 prior to forming additional structures on the substrate in accordance with the method of the instant invention. More specifically, when the insulating layer 16 and sublayer 14 are present, the insulating layer 16 is typically disposed directly on the sublayer 14, and the patterned conductive metal film 12, 18 is typically disposed directly upon the insulating layer 16. The insulating layer 16 is typically formed from inorganic materials (and, thus, is free of organic materials) and is generally resistant to damage in an electrodeposition setup (as described in further detail below). The insulating layer 16 is also typically etchable to enable pattern transfer (as also described in further detail below). One example of a suitable material for the insulating layer 16 is silicon dioxide (SiO₂), which may be used in substantially pure form (i.e., about 99% by weight SiO₂ or greater) or in combination with other components. When present, the insulating layer 16 typically has a thickness of from 1 to 100 nm, more typically from 5 to 80, more typically from 10 to 50 nm. In one specific embodiment, the insulating layer 16 has a thickness of about 20 nm. When the insulating layer 16 includes SiO₂, the insulating layer 16 may be formed on the sublayer 14 by known techniques such as plasma-enhanced chemical vapor deposition (PECVD).

The patterned conductive metal film 12, 18 may be formed in accordance with the method of the instant invention, or the substrate 14, 16 including the patterned conductive metal film 12, 18 may be obtained from a supplier in a pre-formed condition. The patterned conductive metal film 12, 18 has at least one raised feature and defines at least one recess 20 therein adjacent to the at least one raised feature with a surface of the substrate 14, 16 exposed in the at least one recess 20.

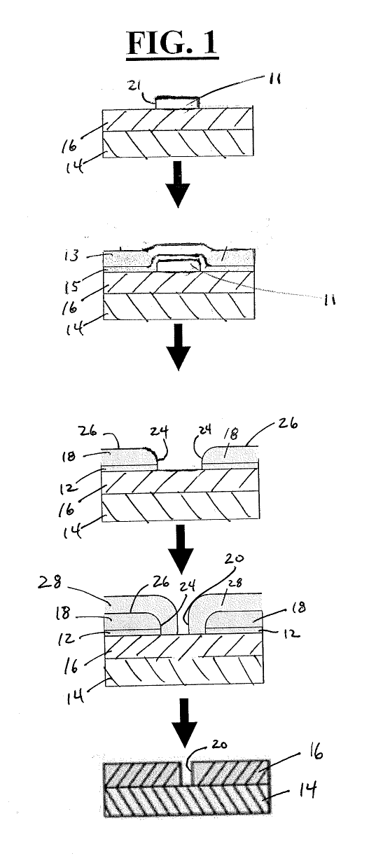

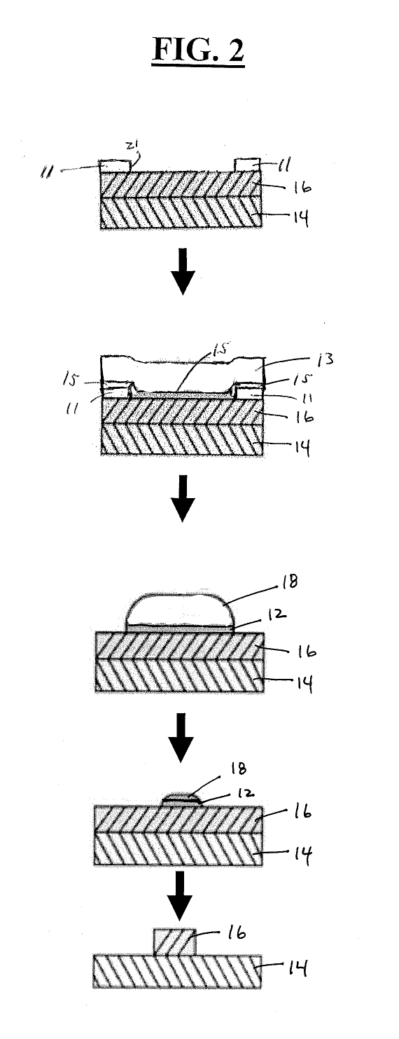

To form the patterned conductive metal film 12, 18, a patterned resist film 11 may be provided on the substrate 14, 16 as shown in the first step of FIGS. 1 and 2. The patterned resist film 11 may be formed on the substrate 14, 16 in accordance with the method of the instant invention. However, it is to be appreciated that the patterned resist film 11 may be provided on the substrate 14, 16 from a supplier in a pre-patterned condition.

The patterned resist film 11 may be formed by applying a liquid resist material onto the substrate 14, 16 through conventional coating methods such as spin-coating the liquid resist material onto the substrate 14, 16. However, it is to be appreciated that the liquid resist material may also be applied by dip-coating, spray-coating, applying liquid droplets onto the substrate 14, 16 prior to any contact printing, or other appropriate coating methods known in the art. The liquid resist material is liquid at room temperature of about 20° C. and may include conventional polymeric materials such as, but not limited to, polystyrene or poly(methyl methacrylate) depending upon the lithography technique to be employed (e.g., when an embossing or imprinting lithography technique is used). Alternatively, the resist material may be a negative or positive photoresist material (when photolithography is used as described in further detail below).

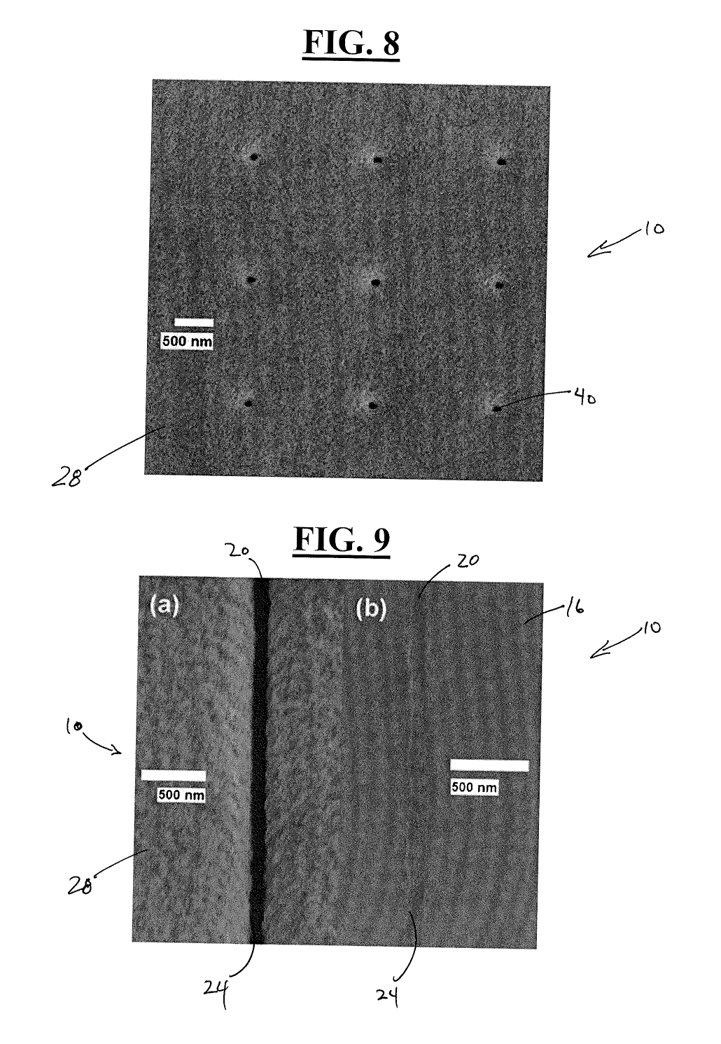

The patterned resist film 11 has at least one raised feature and defines at least one recess 21 therein. The resist recess 21 is adjacent to the at least one raised resist feature. The “raised resist feature” may simply be portions of the patterned resist film 11 that remain after patterning, whereas the at least one “resist recess” may be represented by gaps in the patterned resist film 11 after patterning (which expose the underlying insulating layer 16 when present, as shown in FIG. 1, or which exposed the sublayer 14 when the insulating layer 16 is not present). As such, the at least one “raised resist feature” of the patterned resist film 11 defines the at least one resist recess 21. The at least one raised resist feature and the at least one resist recess 21 provide a surface modulation that enables a conductive metal film 13, 15 to be distinguished when disposed on the raised resist feature and in the resist recess 21, as described in further detail below. Typically, the patterned resist film 11 has a series of raised resist features with a series of resist recesses 21 defined adjacent to the raised resist features. Although the Figures of the instant application illustrate patterns of straight lines (see FIG. 4) or a series of holes 40 (see FIG. 8), it is to be appreciated that the instant invention is not limited to any particular pattern configuration and it is feasible to fabricate complex patterns in accordance with the method of the instant invention.

The pattern of the patterned resist film 11 typically has features that are on the magnitude of microscale dimensions, i.e., features of the pattern typically have at least one dimension such as a length, width, or height (or a void) that measures from 0.5 to 100 μm, alternatively from 0.5 to 10 μm, alternatively from 0.2 to 5 μm. Patterns having features on the magnitude of microscale dimensions may be formed through various mechanisms such as with a mold or through masking and etching. When the mold is used, the pattern is typically formed in the resist film 11 under high pressure and heat. More specifically, a pattern is transferred from a surface of the mold to the resist film 11. Specific examples of processes for forming the pattern in the resist film 11 include, but are not limited to, micro-lithography, such as imprint lithography, thermal embossing, microscale contact printing, UV-assisted imprint lithography, and photolithography. These processes have proven particularly useful in the fabrication of numerous electric and optical devices, and also in wafer-scale processing.

In one specific embodiment, liquid resist material is a photoresist and is spin-coated onto the substrate 14, 16, followed by photolithography performed by a stepper (such as an AutoStep 200) to produce negative patterns within the resist film 11. In particular, lines and dots of the photoresist remain after development of the pattern through the photolithography technique and removal of unexposed portions of the photoresist. The photoresist is cured to form the patterned resist film 11 with the lines and dots representing the “at least one raised resist feature”.

After formation of the pattern in the resist film 11, the conductive metal film 13, 15 is formed by depositing conductive metal on the at least one raised resist feature of the patterned resist film 11 and on the substrate 14, 16 through the at least one resist recess 21 as shown in the second step of FIGS. 1 and 2. The conductive metal film 18 may comprise multiple layers, and the specific conductive metals to be used are not limited within the scope of the instant invention. In one embodiment, the conductive metal film 13, 15 comprises at least two layers; a first layer 15 for promoting adhesion and a second layer 13 having excellent electrical conductivity. For example, the first layer 15 can comprise chromium (Cr) and the second layer 13 can comprise gold (AU). In this particular embodiment, the first layer 15 comprising Cr improves adhesion of the gold in the second layer 13 to the insulating layer 16, especially when the insulating layer 16 comprises SiO₂. In this embodiment, the first layer 15 may have a thickness of from 1 to 50 nm, alternatively from 1 to 20 nm, alternatively from 1 to 5 nm and the second layer 13 may have a thickness of from 1 to 50 nm, alternatively from 5 to 30 nm, alternatively from 10 to 20 nm. In one specific example of this embodiment, a first layer 15 of chromium having a thickness of about 3 nm may be formed on an insulating layer 16 that comprises SiO₂, followed by formation of a second layer 13 of gold having a thickness of about 15 nm, under vacuum of 2×10⁻⁶ Torr. While the manner in which the conductive metal film 13, 15 is deposited on the at least one raised feature of the patterned resist film 11 is not limited, the layer(s) of the conductive metal film 13, 15 may be deposited, for example, by electron beam evaporation.

Typically, the conductive metal film 13, 15 is uniformly disposed on all raised resist features of the patterned resist film 11 and in the resist recesses 21, on the surface of the substrate 14, 16. However, it is to be appreciated that the conductive metal may be selectively deposited on only some of the raised resist features and in only some of the resist recesses 21 to thereby result in some of the raised resist features and resist recesses 21 being free of the conductive metal film 13, 15.

After the conductive metal film 13, 15 is disposed on the raised resist features of the patterned resist film 11 and in the resist recesses 21, the patterned resist film 11 and portions of the conductive metal film 13, 15 that are disposed on the patterned resist film 11 are removed. More specifically, the article 10 including the substrate 14, 16 and the patterned resist film 11 and the conductive metal film 13, 15 disposed thereon is subject to a lift-off process by which the article 10 is immersed in an organic solvent, such as acetone. The acetone dissolves the patterned resist film 11, thereby removing the patterned resist film 11 and portions of the conductive metal film 13, 15 that are disposed thereon. Portions of conductive metal film 13, 15 that are left disposed on the substrate 14, 16 through the at least one resist recess 21 form the patterned conductive metal film 12, 18 on the substrate 14, 16, as shown in the third step of FIGS. 1 and 2. The pattern of the patterned conductive metal film 12, 18, formed in the manner described above, represents a negative pattern of the patterned resist film 11 (with the patterned conductive metal film 12, 18 being disposed on the substrate 14, 16 in resist recesses 21 that were free of the patterned resist film 11).

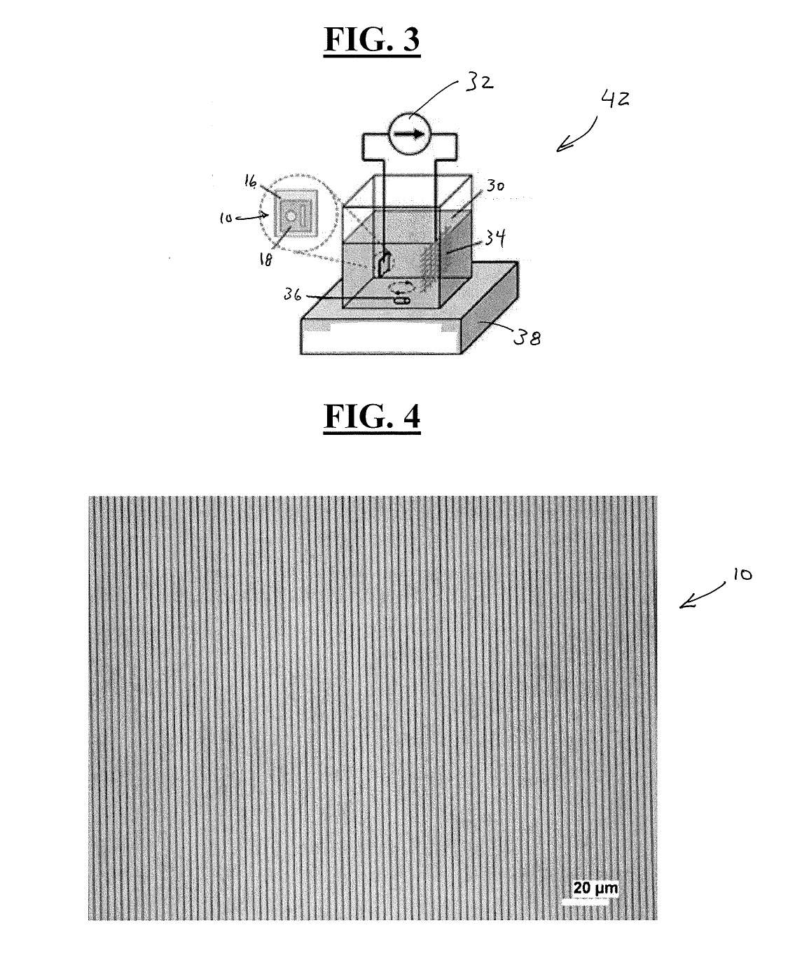

The pattern of the patterned conductive metal film 12, 18 is modified through electrolysis in an electrodeposition setup 42. A typical electrodeposition setup is shown in FIG. 3. The electrodeposition setup 42 includes an electrolyte 30 and two electrodes (represented by the patterned conductive metal film 12, 18, as described in further detail below, and by the counterelectrode indicated at 34). The instant invention is not limited to use of any particular electrolyte 30. The electrodeposition setup 42 may include temperature (heater) and circulation (magnetic stirrer 36) controls 38. One specific example of a suitable electrodeposition setup 42 is a galvanostatic electrolytic cell using a direct-current source. In this example, Enthone BDT 510 electrodeposition solution may be used as the electrolyte 30. The counterelectrode 34 of the cell is an 8×8 cm² platinum grid, while the patterned conductive metal film 12, 18 functions as the other electrode.

Electrolysis is employed to modify the patterned conductive metal film 12, 18, either through deposition onto the patterned conductive metal film 12, 18 or through etching of the patterned conductive metal film 12, 18 depending upon whether the patterned conductive metal film 12, 18 is used as an anode or a cathode within the electrodeposition setup 42. The type of modification of the patterned conductive metal film 12, 18 is determined based upon which features are intended to be shrunk, be it the at least one recess 20 or the raised feature of the patterned conductive metal film 12, 18.

For electrodeposition, the patterned conductive metal film 12, 18 is a cathode in the electrodeposition setup 42. Metal ion source species present in the electrolyte 30 selectively deposit onto the at least one raised feature of the patterned conductive metal film 12, 18, where an electric current supplies electrons for the reduction of metal ions to metal atoms, to form an electrodeposited metal film 28 on the patterned conductive metal film 12, 18. The counterelectrode 34, which functions as an anode in this embodiment, and the patterned conductive metal film 12, 18, which functions as the cathode in this embodiment, may be oriented such that their surface normals are in parallel alignment with each other. In terms of operating variables, low temperatures of less than 70° C. may be employed, which avoid the problems associated with known pattern shrinkage techniques that require higher temperatures. In one particular embodiment, the cell temperature may be from about 45 to about 55° C., typically about 50° C., a stirrer rotation speed may be about 200 revolutions per minute (RPM), and plating current may be about 1 mA. Deposition times may vary according to considerations made clear through additional descriptions below.

As metal ion species are deposited on the at least one raised feature of the patterned conductive metal film 12, 18 through electrodeposition, a dimension of the at least one recess 20 that is defined adjacent to the at least one raised feature of the patterned conductive metal film 12, 18 is reduced. Typically, a width of the at least one recess 20, as measured from sidewall 24 to sidewall 24 of raised features of the patterned conductive metal film 12, 18 (or as measured from electrodeposited metal film 28 that is disposed on the sidewalls 24), is reduced. The sidewalls 24 of the raised features of the patterned conductive metal film 12, 18 that define the at least one recess 20 provide the initial “seeding” for electrodeposition, which will eventually lead to a net, lateral increment of deposition thickness of the electrodeposited metal film 28 on the sidewall 24. This results in the shrinkage of the at least one recess 20 as shown in the fourth step of FIG. 1. While it is possible for some electrodeposition on the insulating layer 16, if exposed, there will be negligible amount of deposition on the insulating layer 16 due to the lack of electron supply.

As set forth above, the patterned resist film 11 typically has features that are on the magnitude of microscale dimensions. The patterned conductive metal film 12, 18, being formed in a negative pattern to the patterned resist film 11, generally has dimensions on the same scale as the patterned resist film 11. Under such circumstances, electrodeposition can be used to reduce the dimension of the at least one recess 20 from microscale dimensions to nanoscale dimensions. It is to be appreciated that the instant invention is not limited to any particular degree of pattern shrinkage through the electrodeposition step. However, in one embodiment, a dimension of the at least one recess 20 is reduced from a size of greater than 200 nm to a size of less than 200 nm, alternatively to a size of less than or equal to 100 nm and represents an advantage of the instant method. In particular, the width of the at least one recess 20, as described above, may be reduced to the dimension set forth above. For example, the width of the at least one recess 20 may start at 680 nm, and may be reduced to 100 nm or lower after electrodeposition on the patterned conductive metal film 12, 18. Of course, when the patterned conductive metal film 12, 18 includes a series of raised features that define a series of recesses 20 adjacent thereto, a dimension of the recesses 20 is reduced through the electrodeposition on the adjacent raised features of the patterned conductive metal film 12, 18, the results of which can be seen in FIGS. 4, 5, and 8.

The types of metals used for electrodeposition are not limited in accordance with the instant invention. Depending on the applications, many different metals can be electrodeposited to suit the purposes of devices that are desired to be formed, such as nanoscale devices. Metals such as aluminum (Al), gold, and silver (Ag), which are frequently used in devices related to bio-sensing and plasmonics, can be economically electrodeposited to modify the pattern of the patterned conductive metal film 12, 18 in accordance with the method of the instant invention. A list of metals that can be electrodeposited can be found in A. K. Graham “Electroplating Engineering Handbook”, 4^{th} ed. (Van Nostrand Reinhold, New York, c1984), the portions thereof that describe suitable metals that can be electrodeposited hereby incorporated by reference.

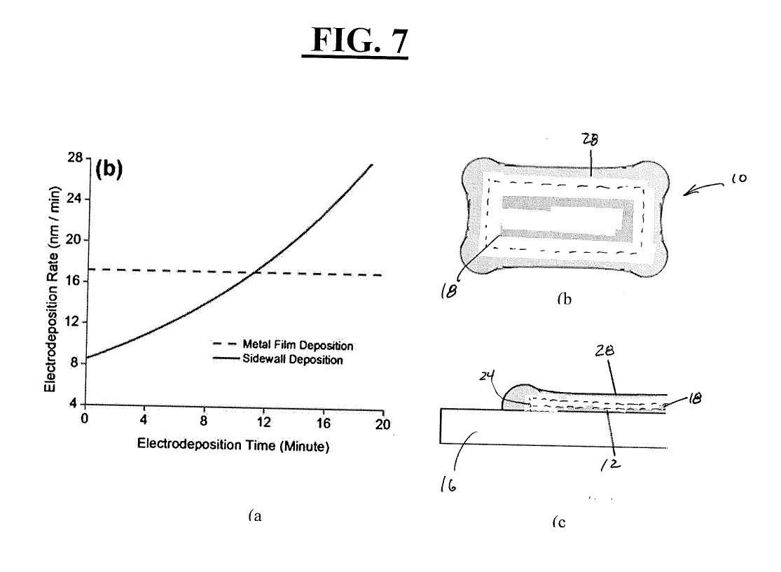

Deposition times have an effect on the magnitude of modification of the pattern, with longer deposition times resulting in a greater magnitude of modification of the pattern (as evidenced by FIG. 6, in which width of a recess 20 is shown as a function of deposition time). Because speed of patterning is a benefit of the method of the instant application, deposition is typically conducted for less than or equal to 25 minutes, typically from 3 to 21 minutes, more typically from 5 to 20 minutes. Of course, deposition time is dictated by both the desired scale of the features in the pattern after deposition and the scale of the initial pattern. As shown in FIGS. 6 and 7(a, the rate of deposition on sidewalls of raised features of the patterned conductive metal film 12, 18 range from 8 to 28 nm per minute (which actually represents the rate of recess shrinkage as the values are multiplied by 2 to account for deposition on two sidewalls for each recess). As can be seen from FIG. 7(a, deposition rate increases with electrodeposition time.

At different times of deposition, the deposition rates of conductive metal on the sidewall 24 and on the upper surface 26 of the patterned conductive metal film 12, 18 may differ. The sidewall deposition rate follows an increasing trend. At the earlier times of deposition (8 and 12 minutes), the sidewall deposition rate is slower than the deposition rate on the upper surface 26 of the patterned conductive metal film 12, 18; however at the prolonged times of deposition (15 and 20 minutes), sidewall deposition rate catches up and exceeds the deposition rate on the upper surface 26 of the patterned conductive metal film 12, 18. During electrodeposition, electric field lines between the anode and the cathode concentrate at the corners of the raised feature of the patterned conductive metal film 12, 18 and cause a high current density there, which may result in an enhanced deposition at the corners. This is the so-called “dog-boning” phenomena in electrodeposition, as hypothetically illustrated in FIG. 7(b. Given long enough duration of deposition, the increased deposition rate could possibly produce the dog-bone-like thickness profile due to the thicker deposition at the corner (on the sidewall 24), as illustrated in FIG. 7(c. Pattern design may take potential dog-boning into account so as to minimize or avoid dog-boning during deposition.

In one embodiment, when the insulating layer 16 is present (optionally, along with the sublayer 14), the electrodeposited metal film 28 may serve as a mask (e.g. etch mask). In particular, in this embodiment, the at least one recess 20 defined by the patterned conductive metal film 12, 18 exposes a surface of the insulating layer 16. The surface of the insulating layer 16 that remains exposed after electrodeposition to form the electrodeposited metal film 28 is etched. By utilizing the electrodeposited metal film 28 as a mask, a pattern of the electrodeposited metal film 28 may be transferred into the insulating layer 16 by etching or lift-off. For example, when the SiO₂ insulating layer 16 is used, the transfer of the pattern into the SiO₂ insulating layer 16 may be carried out by reactive ion etching of SiO₂ using CHF₃ (25 sccm) and Ar (5 sccm), at 20 mTorr with RF power of 150 W.

After pattern transfer into the insulating layer 16, the electrodeposited metal film 28 and the patterned conductive metal film 12, 18 may be removed. When gold is used in the electrodeposited metal film 28 and the patterned conductive metal film 12, 18, the article 10 may be dipped into an iodide-based gold etchant (e.g., Gold Etchant TFA, Transene) to remove the electrodeposited metal film 28 and the patterned conductive metal film 12, 18. Further, when the patterned conductive metal film 12, 18 includes the first layer 12 and second layer 18 with chromium included in the first layer 12, the article 10 may then be dipped into a chromium etchant (e.g., CR-14, Cyantek).

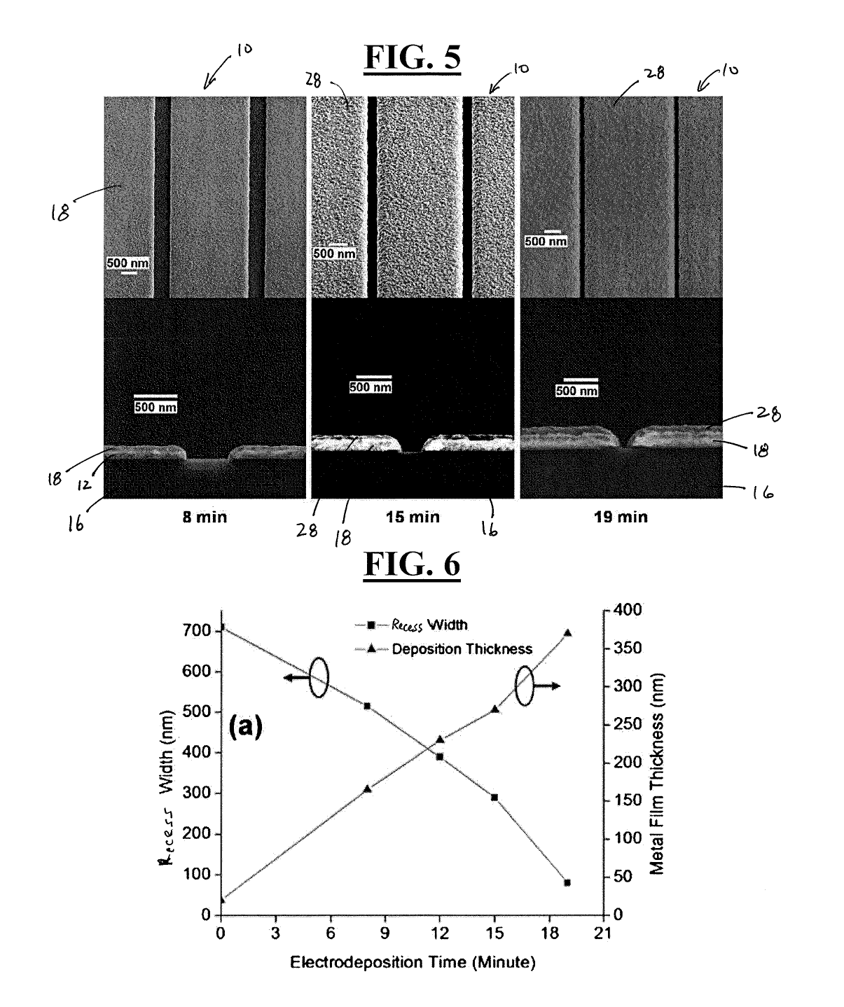

A specific article 10 including a pattern formed through electrodeposition in accordance with the instant invention is shown in FIGS. 9(a) and (b). FIG. 9(a) is a top view of an electrodeposited metal film 28 including raised features that define a recess 20 after electrodeposition of 20 min, which is also shown in FIG. 5. FIG. 9(b) is a SEM top view of the same sample in FIG. 9(a) after reactive ion etching (RIE) of the insulating layer and the removal of chromium and gold layers in the patterned conductive metal film 12, 18. The pattern is transferred through the recess 20 to the insulating layer 16 with high fidelity. The recesses 20 shown in FIG. 9(b) have a width of about 93 nm (averaged over different locations). The width enlargement can be a result of etch bias (lateral undercut) caused by RIE. Both recesses 20 shown in FIGS. 9(a) and (b) appear to be defined by roughened sidewalls 24 of the electrodeposited metal film 28 (or by the insulating layer 16 after removal of the electrodeposited metal film 28), making the recesses 20 wiggly, which phenomenon may be caused by intrinsic surface roughness that arises during electrodeposition. The surface roughness can be reduced upon adjustment of the fundamental parameters of electrodeposition, such as temperature, circulation, solution composition and current density. Pulse electrodeposition, which is known to improve both the thickness uniformity and surface texture of electrodeposition, can also be considered for reducing surface roughness.

As an alternative to electrodeposition, and as alluded to above, the step of modifying the pattern through electrolysis may be further defined as conducting electroetching on the patterned conductive metal film 12, 18. For electroetching, the patterned conductive metal film 12, 18 is an anode in the electrodeposition setup 42. Instead of depositing metal ion source species onto the patterned conductive metal film 12, 18 (as is done in electrodeposition), metal atoms are instead selectively removed from the patterned conductive metal film 12, 18, where the electric current supplies electrons for oxidation of the metal atoms, to form an etched metal film 12, 18 from the patterned conductive metal film 12, 18. The counterelectrode 34, which functions as a cathode in this embodiment, and the patterned conductive metal film 12, 18, which functions as the anode in this embodiment, may be oriented such that their surface normals are in parallel alignment with each other. In terms of operating variables, as with electrodeposition, low temperatures of less than 70° C. may be employed, which avoid the problems associated with known pattern shrinkage techniques that require higher temperatures. In one particular embodiment, the cell temperature may be from about 45 to about 55° C., typically about 50° C., a stirrer rotation speed may be about 200 revolutions per minute (RPM), and plating current may be about 1 mA. Etching times may vary according to considerations made clear through additional descriptions below.

As metal atoms are etched from the patterned conductive metal film 12, 18 through electroetching, a dimension of the patterned conductive metal film 12, 18 is reduced. In this regard, as shown in FIG. 2, the dimension of the at least one raised feature may be reduced by electroetching the patterned conductive metal film 12, 18. This results in the shrinkage of the at least one raised feature of the patterned conductive metal film 12, 18.

As set forth above, the patterned resist film 11 typically has features that are on the magnitude of microscale dimensions. The patterned conductive metal film 12, 18, being formed in a negative pattern to the patterned resist film 11, generally has dimensions on the same scale as the patterned resist film 11. Electroetching may be employed to reduce the dimension of the at least one raised feature in the patterned conductive metal film 12, 18 from microscale dimensions to nanoscale dimensions. It is to be appreciated that the instant invention is not limited to any particular degree of pattern shrinkage through the electroetching step. However, in one embodiment, a dimension of the at least one raised feature in the patterned conductive metal film 12, 18 is reduced from a size of greater than 200 nm to a size of less than 200 nm, alternatively to a size of less than or equal to 100 nm, and represents an advantage of the instant method. Typically, the dimension of the at least one raised feature of the patterned conductive metal film 12, 18 that is reduced is the width thereof, as measured between recesses 20. In one example, the width of the at least one raised feature of the patterned conductive metal film 12, 18 may start at 680 nm, and may be reduced to 100 nm or lower after electroetching the at least one raised feature of the patterned conductive metal film 12, 18. Of course, when a series of raised features are present in the patterned conductive metal film 12, 18, a dimension of the raised features in the patterned conductive metal film 12, 18 is reduced through electroetching to form the etched metal film 12, 18.

In one embodiment, when the sublayer 14 and the insulating layer 16 disposed directly thereon are present, and the patterned conductive metal film 12, 18 is disposed directly upon the insulating layer 16, the at least one raised feature of the etched metal film 12, 18 may serve as a mask (e.g. etch mask). In particular, in this embodiment, the surface of the insulating layer 16 that is exposed after electroetching the at least one raised feature of the patterned conductive metal film 12, 18 to form the etched metal film 12, 18 is etched to transfer a pattern of the etched metal film 12, 18 into the insulating layer 16. By utilizing the etched metal film 12, 18 as a mask, a pattern of the etched metal film 12, 18 may be transferred into the insulating layer 16 by etching or lift-off as described above in the context of electrodeposition.

After pattern transfer into the insulating layer 16, the etched metal film 12, 18 may be removed through the manner described above in the context of electrodeposition. However, it is to be appreciated that in some embodiments, it may be desirable to leave the etched metal film 12, 18 in place.

The following Examples are intended to supplement the description of the invention and are not to be interpreted as limiting to the invention.

### EXAMPLES

In the following Examples, gold (Au) is used in a second layer of the patterned conductive metal film, and pattern shrinkage is carried out by electrodeposition of gold. A 20 nm-thick silicon dioxide (SiO₂) insulating layer was deposited on a silicon (Si) sublayer by plasma-enhanced chemical vapor deposition (PECVD). A photoresist was spin-coated onto the insulating layer, and photolithography was performed by a stepper (AutoStep 200) to produce negative patterns (remaining after the development) of raised resist features including lines and dots (i.e., resist recesses). Upon the development of the photoresist, a patterned resist film including the raised resist features of lines and dots was obtained.

A conductive metal film was formed on the raised resist features of the patterned resist film through electron beam evaporation of 3 nm of chromium (Cr) on the patterned resist film to form a first layer of the conductive metal film, followed by 15 nm of gold (Au), under the vacuum of 2×10⁻⁶ Torr, to form the second layer of the conductive metal film. After lift-off (by which the patterned resist film is removed along with portions of the conductive metal film disposed thereon), a patterned conductive metal film (Cr/Au) having lines (i.e., raised features) defining recesses and holes is formed. Recesses between the lines have a width, as measured from a sidewall of one line to the sidewall of the next line, of 710 nm, length 1 cm and period of 3 μm; recesses that are holes have a diameter of about 680 nm and period of 2 μm.

The same patterning procedures described above were repeated to produce multiple but identical samples with each going through different duration of electrodeposition. A typical electrodeposition setup used in this experiment is shown in FIG. 3. The electrodeposition setup uses Enthone BDT 510 electrodeposition solution as the electrolyte with temperature (heater) and circulation (magnetic stirrer) control. It is a galvanostatic electrolytic cell using a direct-current source. The anode of the cell is an 8×8 cm² platinum grid, while the cathode is electrically connected to the patterned conductive metal film, where gold ions are reduced to and deposited as gold atoms on the gold film. The anode and the samples (cathode) were oriented such that their surface normals were in parallel alignment with each other. Electrodeposition was conducted using the same condition with cell temperature of 50° C., stirrer rotation speed of 200 revolutions per minute (RPM) and plating current of 1 mA. Pattern transfer into the SiO₂ insulating layer was carried out by reactive ion etching of SiO₂ using CHF_{3 (}25 sccm) and Ar (5 sccm), at 20 mTorr with RF power of 150 W. The electrodeposited metal films were removed by first dipping the sample into the iodide-based gold etchant (Gold Etchant TFA, Transene), and then into the chromium etchant (CR-14, Cyantek). The nominal etch rate of chromium or gold in these etchants is 3 nm/s, and the samples were deliberately over-etched in each etchant for 30 minutes to ensure complete removal of the electrodeposited metal film.

FIG. 5 shows the top and cross-sectional views of the SEM images for electrodeposited metal films that define recesses therebetween where electrodeposition was conducted for different amount of time: 8, 15 and 20 minutes. From the top views, the shrinkage of the recess width is observed to be uniform across the array and along the recess length of 1 cm. The recess width, as measured at a base of the recess, and the electrodeposited metal film thickness were measured from the cross-sectional SEM images. Here the electrodeposited metal film thickness refers to the thickness of the metal deposited directly above the SiO₂ surface, which differs from the deposition on the sidewall of the raised features which results in the shrinkage of the recess's base width. For each sample, multiple SEM cross-sections were repeatedly taken at different locations of the electrodeposited metal film samples and the measured dimensions were averaged and summarized as a plot in FIG. 6. Both FIG. 5 and FIG. 6 indicate that the shrinkage technique follows intuitively from the electrodeposition of gold on the sidewall. The cross-sections shown in FIG. 5 also indicate the high selectivity of the deposition, manifested by the negligible deposition of metal on the surface of the substrate in the bottom of the recesses.

At different times of deposition, the deposition rates of gold on the sidewall of the raised features of the patterned conductive metal film and on the upper surface of the patterned conductive metal film are shown in FIG. 7(a. The deposition rates are obtained from measuring the deposition thickness from the cross-sectional SEM images shown in FIG. 5. The sidewall deposition rate is calculated by dividing the rate of recess width shrinkage (as measured at a base thereof) by two, owing to the fact that the recess width shrinkage is a result of the deposition on two sidewalls. From FIG. 7(a, the sidewall deposition rate follows an increasing trend. At the earlier times of deposition (8 and 12 minutes), the sidewall deposition rate is slower than the deposition rate on the upper surface of the patterned conductive metal film; however at the prolonged times of deposition (15 and 20 minutes), it catches up and exceeds the deposition rate on the upper surface of the patterned conductive metal film, and the increase in sidewall deposition rate can be attributed to the enhanced deposition at the corners commonly observed in electrodeposition. During electrodeposition, electric field lines between the anode and the cathode concentrate at the corners and may cause a high current density there, possibly resulting in an enhanced deposition at the corners. This is the so-called “dog-boning” phenomena in electrodeposition, as hypothetically illustrated in FIG. 7(b. When applying the same scenario to the instant setting of shrinkage technique, the increasing sidewall deposition rate can be the result of increased current density at the vicinity of the corner. Given long enough duration of deposition, the increased deposition rate can produce the dog-bone-like thickness profile due to the thicker deposition at the corner (on the sidewall), as illustrated in FIG. 7(c. FIG. 8 shows the shrinkage of holes after 13 minutes of electrodeposition. The diameter of the holes started at 680 nm and was reduced to 100 nm after the electrodeposition.

The result of pattern transfer is shown in FIG. 9. FIG. 9(a) is the zoomed-in top view of a recess after electrodeposition of 20 min, which is also shown in FIG. 5. FIG. 9(b) is the SEM top view of the same sample in (a) after RIE of SiO₂ and the removal of chromium and gold layers. The shrunk patterns on the gold layer were transferred to the SiO₂ insulating layer with high fidelity. The recesses shown in FIG. 9(b) have a width of about 93 nm (averaged over different locations). The width enlargement can be a result of etch bias (lateral undercut) caused by RIE. Both recesses shown in FIG. 9 appear to be defined by roughened sidewalls of the electrodeposited metal film (or SiO₂ insulating layer after removal of the electrodeposited metal film), making the recesses wiggly. This could be caused by the intrinsic surface roughness that arises during electrodeposition. The surface roughness can be reduced upon the adjustment of the fundamental parameters of electrodeposition, such as temperature, circulation, solution composition and current density.

Obviously, many modifications and variations of the present invention are possible in light of the above teachings, and the invention may be practiced otherwise than as specifically described within the scope of the appended claims. It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

What is claimed is:

1. A method of patterning comprising the steps of:
providing a substrate having a patterned conductive metal film disposed thereon, the patterned conductive metal film having at least one raised feature and defining at least one recess therein adjacent to the at least one raised feature with a surface of the substrate exposed in the at least one recess; and
modifying the pattern through electrolysis in an electrodeposition setup including an electrolyte and two electrodes, wherein the patterned conductive metal film is one of the electrodes.

2. A method as set forth in claim 1 wherein the step of providing the substrate comprises providing a patterned resist film on the substrate, the patterned resist film having at least one raised feature and defining at least one recess therein adjacent to the at least one raised feature with the surface of the substrate exposed in the recess, and depositing conductive metal on the at least one raised feature of the patterned resist film and on the substrate through the at least one recess to form a conductive metal film.

3. A method as set forth in claim 2 wherein the step of providing the substrate further comprises the step of removing the patterned resist film and portions of the conductive metal film disposed thereon, thereby leaving portions of conductive metal film disposed on the substrate through the at least one recess to form the patterned conductive metal film on the substrate.

4. A method as set forth in claim 1 wherein the step of modifying the pattern is further defined as conducting electrodeposition on the patterned conductive metal film wherein the patterned conductive metal film is a cathode in the electrodeposition setup and wherein metal ion source species selectively deposit onto the patterned conductive metal film to form an electrodeposited metal film thereon.

5. A method as set forth in claim 4 wherein a dimension of the at least one recess is reduced through the electrodeposition on the at least one raised feature of the adjacent patterned conductive metal film.

6. A method as set forth in claim 5 wherein the dimension of the at least one recess is reduced from a size of greater than 200 nm to a size of less than 200 nm.

7. A method as set forth in claim 5 wherein a series of recesses are defined adjacent to a series of raised features in the patterned conductive metal film and wherein a dimension of the recesses is reduced through the electrodeposition on the raised features of the adjacent patterned conductive metal film.

8. A method as set forth in claim 5 wherein the substrate includes a sublayer and an insulating layer disposed directly thereon, and wherein the patterned conductive metal film is disposed directly upon the insulating layer.

9. A method as set forth in claim 8 wherein the surface of the insulating layer exposed after electrodeposition is etched to transfer a pattern of the electrodeposited metal film into the insulating layer.

10. A method as set forth in claim 9 wherein electrodeposited metal film and patterned conductive metal film are removed.

11. A method as set forth in claim 1 wherein the step of modifying the pattern is further defined as conducting electroetching on the patterned conductive metal film wherein the conductive metal film is an anode in the electrodeposition setup and wherein metal atoms are selectively removed from the patterned conductive metal film to form an etched metal film.

12. A method as set forth in claim 11 wherein a dimension of the at least one raised feature in the patterned conductive metal film is reduced from a size of greater than 200 nm to a size of less than 200 nm in the etched metal film.

13. A method as set forth in claim 11 wherein the patterned conductive metal film has a series of raised features and wherein a dimension of the raised features is reduced through electroetching to form the etched metal film.

14. A method as set forth in claim 11 wherein the substrate includes a sublayer and an insulating layer disposed directly thereon, and wherein the patterned conductive metal film is disposed directly upon the insulating layer.

15. A method as set forth in claim 14 wherein the surface of the insulating layer exposed after electroetching is etched to transfer a pattern of the etched metal film into the insulating layer.

16. A method as set forth in claim 15 wherein the etched metal film and underlying patterned conductive metal film are removed.

17. An article having a patterned structure defined therein, said article formed through the method as set forth in claim 1.

18. An article as set forth in claim 17 wherein metal ion source species selectively deposit onto the patterned conductive metal film to form an electrodeposited metal film thereon.

19. An article as set forth in claim 18 wherein a dimension of said at least one recess is reduced through the electrodeposition on the at least one raised feature of the adjacent patterned conductive metal film and wherein the dimension of the at least one recess is less than 200 nm.

20. An article as set forth in claim 17 wherein metal ion source species are selectively removed from the patterned conductive metal film to form an etched metal film and wherein a dimension of the etched metal film on the at least one raised feature is less than 200 nm.
